(19) United States
(12) Patent Application Publication
(10) Pub. No.: US 2006/0219493 A1
(43) Pub. Date: Oct. 5, 2006

(54) Automatic shoe clearance adjustment apparatus

(75) Inventors: Yuusuke Taniguchi, Tatebayashi-shi (JP); Nobuhisa Arai, Toyoake-shi (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Nisshinbo Industries, Inc., Tokyo (JP)

(21) Appl. No.: 11/390,029

(22) Filed: Mar. 27, 2006

(30) Foreign Application Priority Data
Mar. 31, 2005 (JP) JP2005-102958

(51) Int. Cl. F16D 55/02

(52) U.S. Cl. 188/71.7

(57) ABSTRACT

To reduce the number of components of the automatic shoe clearance adjustment apparatus and to improve the ease of assembly of the same, the proximal portion of the driving member is fixed on the strut. The operating portion and the arm of the driving member are integrally formed therewith is placed between the brake shoe and the strut. The operating portion together with the arm of the driving member are moved (rotated) so as to follow the movement of the brake shoe by utilizing the resilient force of the driving member, and the pawl at the end of the arm drives the adjustment teeth of the strut to extend the entire length of the strut.

### FIELD OF THE INVENTION

This invention relates to an automatic shoe clearance adjustment apparatus for a drum brake device.

### BACKGROUND OF THE INVENTION

An example of this type of automatic shoe clearance adjustment apparatus is described in Japanese Provisional Patent Publication No. 58-77931 and European Provisional Patent Publication No. 0077726 (Related prior art 1). The automatic shoe clearance adjustment apparatus is comprised of a strut extended between a pair of brake shoes and a driving member to make a ratchet engagement with adjustment teeth integrated with the strut and adjusts the shoe-to-drum clearance automatically by extending an entire length of the strut when a shoe-to-drum clearance increases because a brake lining is worn out.

The strut disclosed in the related prior art 1, as shown in FIGS. 19 and 20, has a screw-engaging unit fitting a bolt 61 to a nut 62 having adjustment teeth 62a and a socket 63 slidably fitting on a screw-stem of the bolt 61 and abutting against the nut 62 via a lever 73 at an end surface of a fitting portion thereof. One end of the bolt 61 and the socket 63 respectively engage with the brake shoe (not shown in the figures).

A driving member 70 is comprised of a resilient blade 71, a pawl 72 and a lever 73. A proximal end of the resilient blade 71 is fixed on the socket 63 by a rivet 64. An end of the pawl 72 engages with the adjustment teeth 62a integrated with the nut 62. A washer-like portion 73b of the lever 73 is slidably fitted on an outside of the bolt 61 and an arm 73a, integrally extending from the washer-like portion 73b, supports a back surface of the resilient blade 71. The driving member 70 is assembled in the strut 60 to constitute the automatic shoe clearance adjustment apparatus.

The operation of the above-described automatic shoe clearance adjustment apparatus is explained next. The resilient blade 71 is supported by the lever 73 in a direction to move away from the adjustment teeth 62a of the nut 62. Then, as a pair of brake shoes spread apart from each other, the washer-like portion 73b of the lever 73 leans between end surfaces of the nut 62 and the socket 63, and an end of the arm 73a approaches the socket 63. The resilient blade 71 approaches the adjustment teeth 62a according to the movement of the arm 73a, when the brake shoes spread apart while a shoe-to-drum clearance exceeds a predetermined value or range (while a brake lining is worn out), a pawl 72 drives the adjustment teeth 62a by a resilient force of the resilient blade 71, thereby rotating the nut 62 relative to the bolt 61. If the strut 60 is pressed by a force of the shoe return spring via the brake shoes, the pawl 72 runs over the adjustment teeth 62a, which extends an entire length of the strut 60, thereby performing the automatic shoe clearance adjustment operation.

In the conventional automatic shoe clearance adjustment apparatus, the driving member 70 is comprised of large number of components with four elements 64, 71, 72, and 73 and some parts comprising thereof have complicated shapes, thereby increasing the material, manufacturing and assembling costs. Also, when the shoe clearance adjustment operation is in motion, the washer-like portion 73b of the lever 73 leans, and particularly a biasing force is applied to the nut 62, which increases a rotational resistance of the nut 62. Accordingly, the shoe clearance adjustment operation became unstable.

Problems of the conventional technology to be resolved by this invention are that the conventional technology involves a large number of components; the automatic shoe clearance adjustment apparatus is excessively complex; and the biasing force applied to the nut (rotating member) makes the shoe clearance adjustment operation unstable.

### SUMMARY OF THE INVENTION

This invention is to provide lower cost with less complexity and further to provide a stable shoe clearance adjustment operation mainly by fixing a proximal portion of the driving member to the strut, resiliently abutting the operating portion extendedly formed from the proximal portion against the brake shoe between the brake shoe and the strut, and engaging a pawl end of an arm extending toward adjustment teeth of the strut from the operating portion with the adjustment teeth.

A first invention of this application relates to an automatic shoe clearance adjustment apparatus having a strut and a driving member, the strut is comprised of a screw-engaging unit having a nut and a bolt screwed therebetween and a fitting member rotatably fitting with the screw-engaging unit, and extended between one brake shoe and the other brake shoe, and the driving member engages with adjustment teeth integrated with the screw-engaging unit of the strut, in which the automatic shoe clearance adjustment apparatus has an automatic shoe clearance adjustment mechanism, automatically extending an entire length of the strut to adjust a shoe-to-drum clearance by driving the adjustment teeth in one direction when strokes of the brake shoes exceed a predetermined value or range, wherein the driving member is comprised of a proximal portion fixed on the strut at a side being near to the one brake shoe, an operating portion extending from the proximal portion and resiliently abutting against the one brake shoe between the one brake shoe and the strut in a longitudinal direction of the strut, and an arm having a pawl extending from the operating portion toward the adjustment teeth to make an engagement therebetween.

A second invention related to the above-automatic shoe clearance adjustment apparatus as above, wherein the proximal portion of the driving member is fixed to an axial line of the strut, and the operating portion of the driving member abuts against the one brake shoe on the axial line of the strut between the one brake shoe and the proximal portion.

A third invention relates to the above-automatic shoe clearance adjustment apparatus as above, wherein the proximal portion of the driving member is fixed to the strut by fitting.

A fourth invention relates to the above-automatic shoe clearance adjustment apparatus as above, wherein the adjustment teeth is integrally formed with the bolt of the screw-engaging unit, and the fitting member engages with one of the pair of brake shoes and the nut engages with the other of the pair of brake shoes.

A fifth invention relates to the above-automatic shoe clearance adjustment apparatus as above, wherein the adjustment teeth is integrally formed with the nut of the screw-engaging unit, and the fitting member engages with one of the pair of brake shoes and the bolt engages with the other of the pair of brake shoes.

A sixth invention relates to the above-automatic shoe clearance adjustment apparatus as above, wherein an over adjustment prevention means is provided on the arm of the driving member, the over adjustment prevention means suspends an automatic shoe clearance adjustment operation by disengaging the arm from the adjustment teeth by thermo-deflecting of the arm when a temperature within the brake exceeds a predetermined value or range.

The automatic shoe clearance adjustment apparatus of this invention has the following advantages.

<1> The driving member can be made from a piece of plate spring, which significantly reduces the number of components necessary to constitute the driving member and also reduces the manufacturing cost of the driving member, which reduces the parts cost of the automatic shoe clearance adjustment apparatus.

<2> The driving member can be fixed to the strut by the fitting means, which reduces the assembling cost.

<3> The driving member can be stably fixed to an axial line of the strut, which creates smooth operation of the driving member and gives stable shoe clearance adjustment operation.

<4> This invention is applicable to various types of struts, which gives a wide range of industrial applicability.

### BRIEF DESCRIPTION OF THE DRAWINGS

The above and other objects of the present invention will become readily apparent by reference to the following detailed description when considered in conjunction with the accompanying drawings wherein:

FIG. 1 is a plan view of the drum brake employing the automatic shoe clearance adjustment apparatus according to the first embodiment of this invention;

FIG. 2 is a cross section view of FIG. 1 taken along the line II-II;

FIG. 3 is an assembly view of a partially cutaway shoe clearance adjustment apparatus

FIG. 4 is a plan view of the driving member placed between the brake shoe and the strut;

FIG. 5 is an explanatory view of the automatic shoe clearance adjustment apparatus according to the second embodiment;

FIG. 6 is a perspective view of the driving member of the automatic shoe clearance adjustment apparatus according to the second embodiment;

FIG. 7 is a plan view of the driving member installed between the brake shoe and the strut according to the second embodiment;

FIG. 8 is an explanatory view of the automatic shoe clearance adjustment apparatus according to the third embodiment

FIG. 9 is a perspective view of the automatic shoe clearance adjustment apparatus according to the third embodiment;

FIG. 10 is a plan view of the driving member placed between the brake shoe and the strut according to the third embodiment;

FIG. 11 is a side view of the driving member placed between the brake shoe and the strut according to the third embodiment;

FIG. 12 is an explanatory view of the automatic shoe clearance adjustment apparatus according to the fourth embodiment;

FIG. 13 is a perspective view of the driving member of the automatic shoe clearance adjustment device according to the fourth embodiment;

FIG. 14 is a plan view of the driving member placed between the brake shoe and the strut according to the fourth embodiment;

FIG. 15 is an explanatory view of the automatic shoe clearance adjustment apparatus according to the fifth embodiment;

FIG. 16 is a perspective view of the driving member of the automatic shoe clearance adjustment apparatus according to the fifth embodiment;

FIG. 17 is a plan view of the driving member placed between the brake shoe and the strut according to the fifth embodiment;

FIG. 18 is an explanatory view of the automatic shoe clearance adjustment apparatus according to the sixth embodiment having the over-adjustment prevention means in the driving member 50, wherein FIG. 18A is an explanatory view prior to the thermo-deformation of the arm while FIG. 18B is the arm as being thermo-deformed;

FIG. 19 is a plan view of the conventional automatic shoe clearance adjustment apparatus; and

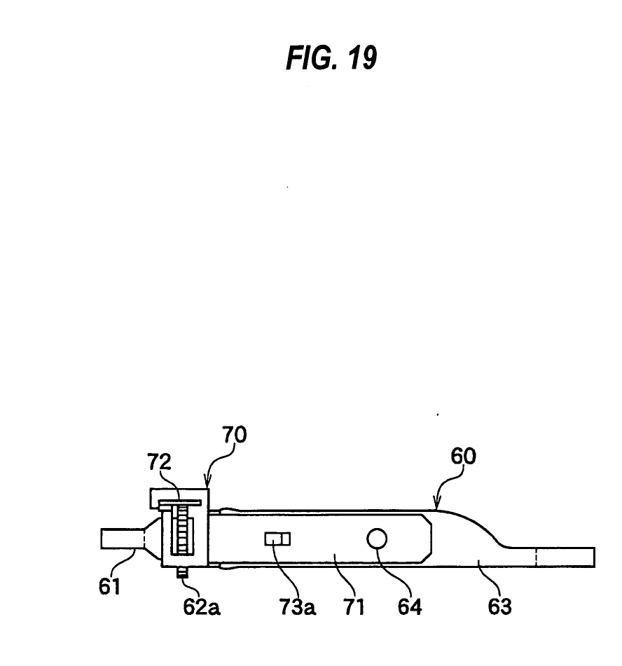

FIG. 20 is a cross section view of the conventional automatic shoe clearance adjustment apparatus.

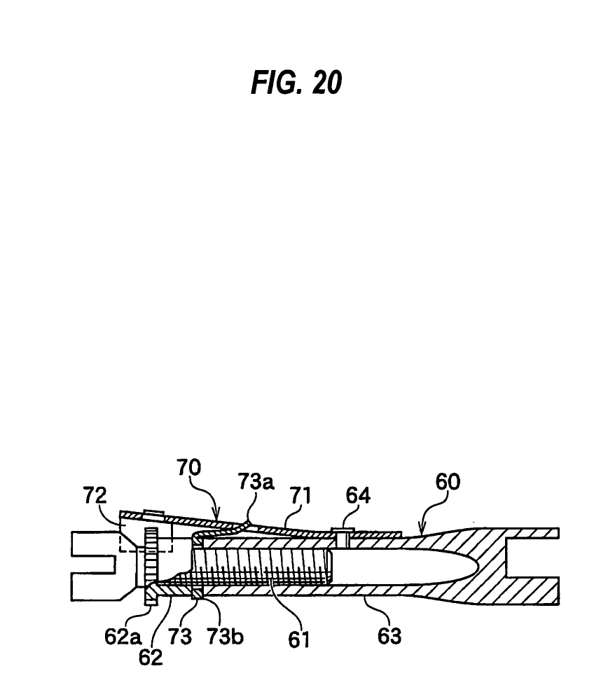

### DESCRIPTION OF THE PREFERRED EMBODIMENTS

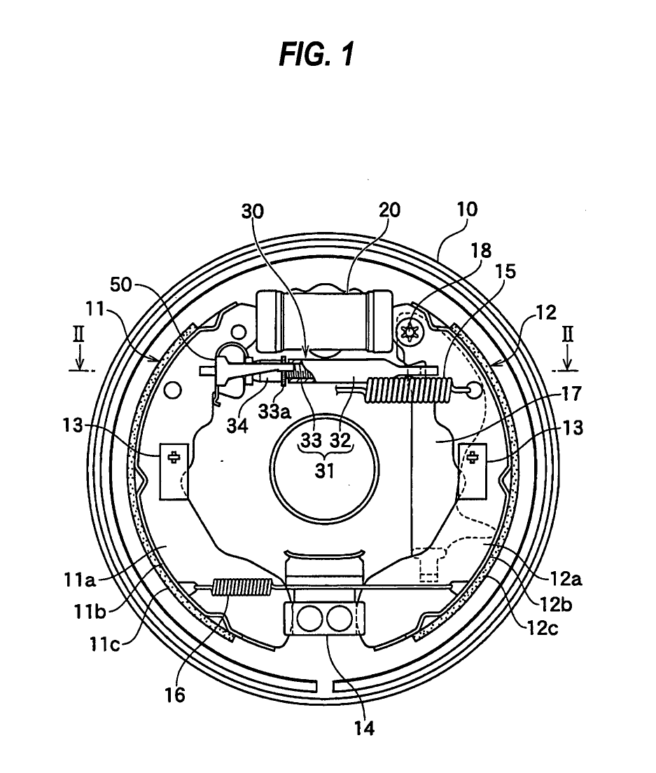

Embodiments of this invention will be explained with reference to the accompanied drawings. A first embodiment of an automatic shoe clearance adjustment apparatus of this invention will be explained with reference to FIGS. 1-4.

<1> Overview of Drum Brake Device

FIG. 1 shows a drum brake device with the automatic shoe clearance adjustment apparatus of the first embodiment. This embodiment illustrates an embodiment of employing an incremental type automatic shoe clearance adjustment apparatus in a leading-trailing (LT) type drum brake device.

In FIG. 1, shoe webs 11a, 12a are jointed with shoe rims 11b, 12b respectively to make a T-shape in cross section, and linings 11c, 12c are bonded on the peripheral surfaces of the shoe rims 11b, 12b respectively, thereby forming a pair of brake shoes, i.e., a first brake shoe 11 and a second brake shoe 12. The first and second brake shoes 11, 12 are slidably mounted, by publicly known shoe hold mechanisms 13, 13, on a back plate 10 which is fixed to a stationary portion of a vehicle by an attachment means, such as bolts.

One ends of the pair of brake shoes 11, 12 (upper ends in FIG. 1) engages with a wheel cylinder 20 functioning as a shoe expander for the service brake and the other ends (lower ends in FIG. 1) are supported by an anchor 14 fixed on the back plate 10. The pair of brake shoes 11 and 12 are abutting against the wheel cylinder 20 and the anchor 14 by a spring force of shoe return springs 15, 16 extended between a pair of facing one end sides (upper sides in FIG. 1) and a pair of facing the other end sides (lower sides in FIG. 1) of the pair of brake shoes 11 and 12.

A brake lever 17, functioning as the shoe expander for the parking brake, is superposed on the shoe web 12a of the second brake shoe 12, and the proximal end of which is pivotally supported around one end of the shoe web 12a by a pin 18. Also, a brake cable, not shown in FIG. 1, is connected to a free end of the brake lever 17 for transmitting a remotely controlling force.

<2> Overview of the Automatic Shoe Clearance Adjustment apparatus

The automatic shoe clearance adjustment apparatus is comprised of a strut 30 which is extended between the facing brake shoes 11, 12 adjacent to the wheel cylinder 20 for restricting the returning position of the brake shoes 11, 12 and a driving member 50 which extends the entire length of the strut 30. The structure of the automatic shoe clearance adjustment apparatus will be explained next.

<3> Strut

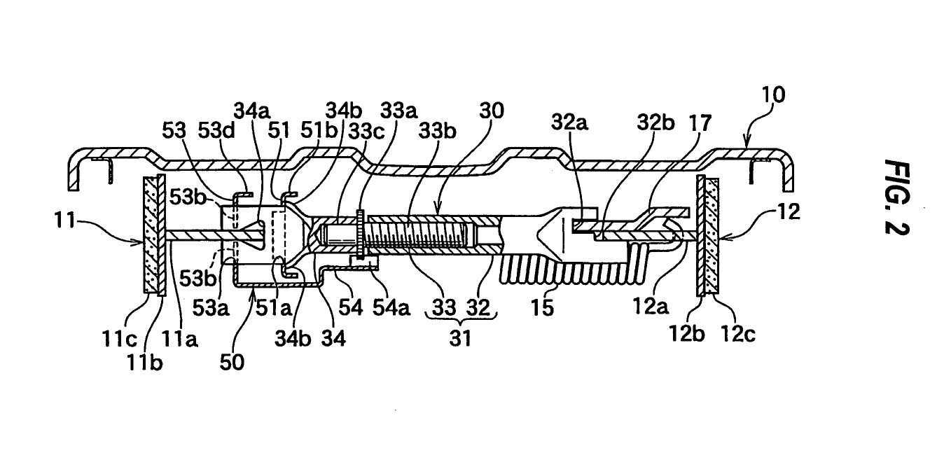

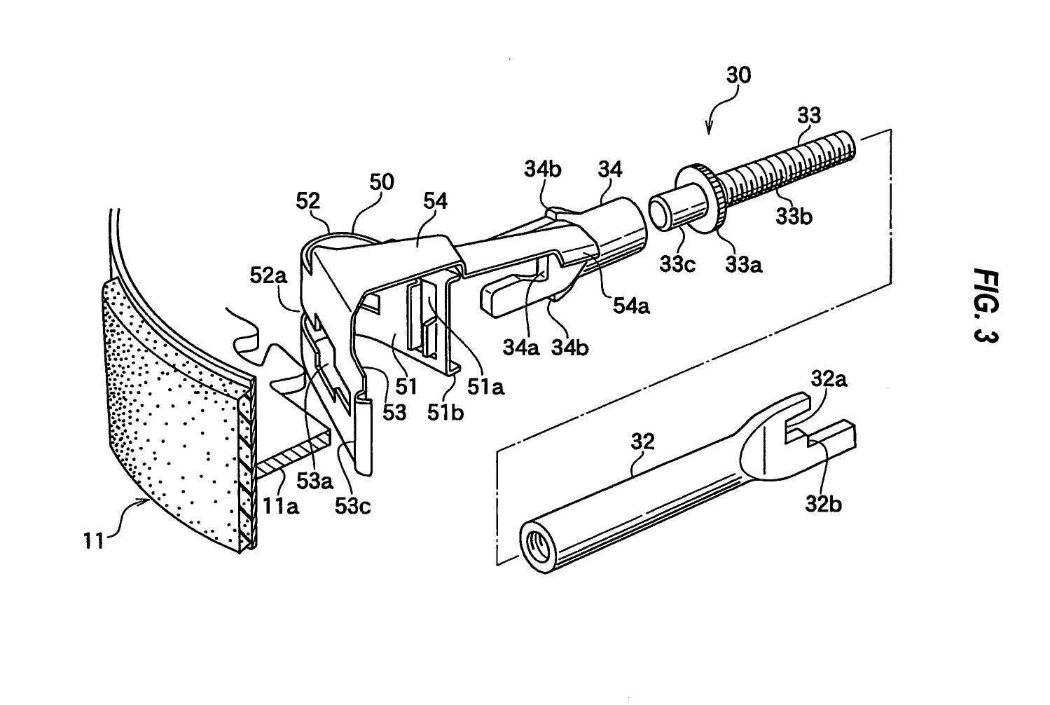

A structure of the strut 30 will be explained according to FIGS. 2 and 3. The strut 30 is comprised of a screw-engaging unit 31 having the nut 32 and the bolt 33 screwed therebetween and a fitting member 34 rotatably fitting to the screw-engaging unit 31.

Adjustment teeth 33a with small teeth therearound are integrally formed on an intermediate portion of the bolt 33. A right screw-stem 33b of the bolt 33 screw-engages in the nut 32 and a left fitting-stem 33c of the bolt 33 slidably and rotatably fit to a bore of the fitting member 34.

A notched groove 32a and a stepped portion 32b continuing from the notched groove 32a are formed around a right flat end of the nut 32. The brake lever 17 fits in the notched groove 32a and the shoe web 12a of the second brake shoe 12 fits in a space formed between the stepped portion 32b and the brake lever 17, thereby disabling the rotation of the nut 32.

A notched groove 34a is formed around a left flat end of the fitting member 34. The shoe web 11a of the first brake shoe 11 fits in the notched groove 34a, thereby disabling the rotation of the fitting member 34. As such, the bolt 33 is rotated via the adjustment teeth 33a, which enables the nut 32 to screw in or out from the bolt 33. A projection 34b, being abuttable against the driving member 50, is formed around a border of the flat end and a cylindrical portion of the fitting member 34. When an insertion hole 51a formed on the proximal portion 51 fits to the flat end of the fitting member 34, a plate surface of the proximal portion 51 abuts against the projection 34b to restrict the depth of the insertion thereof.

<4> Driving Member

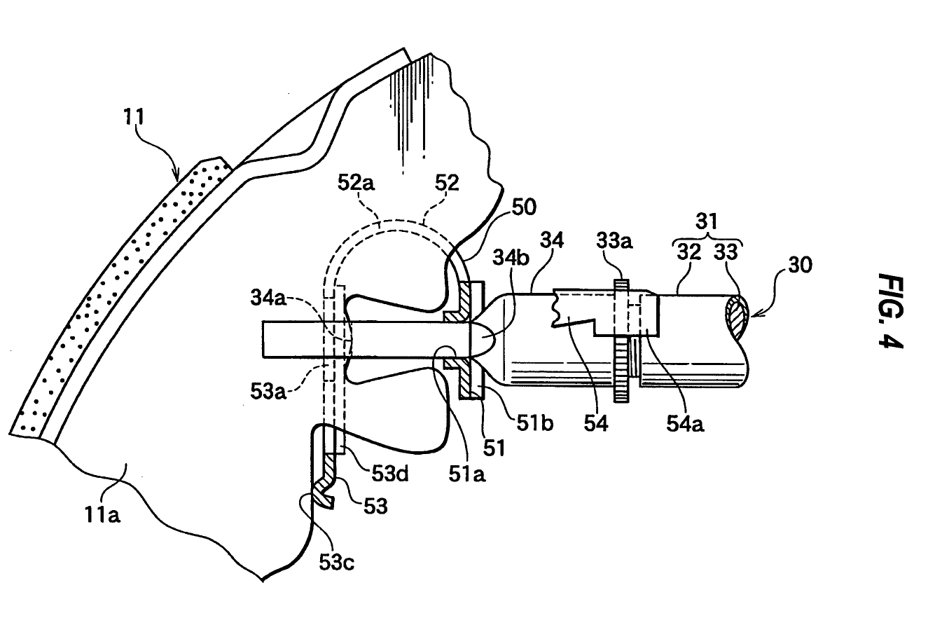

FIG. 3 shows a perspective view of the driving member 50 and peripheral components relating to the driving member 50 and FIGS. 2 and 4 show the driving member 50 being assembled between the strut 30 and the first brake shoe 11. The driving member 50 is comprised of the proximal portion 51 which is fixed to the fitting member 34 of the strut 30 at a side being near to the first brake shoe 11, an arc portion 52 which is formed by extending the proximal portion 51 and bending, an operating portion 53 which is formed by extending the arc portion 52 to resiliently abut against the first brake shoe 11 between the first brake shoe 11 and the strut 30 at a longitudinal direction of the strut 30, and an arm 54 which is formed by extending from the operating portion 53 toward the adjustment teeth 33a of the strut 30 and is formed with a pawl 54a to make a ratchet engagement with the adjustment teeth 33a so as to drive the adjustment teeth 33a in one direction at an end thereof.

A strip section, which is composed of the proximal portion 51, the arc portion 52, and the operating portion 53, is shaped in almost a V while it is free. Then, the insertion hole 51a is opened in the plate surface of the proximal portion 51 so that the insertion hole 51a is enabled to receive the flat end of the fitting member 34 and the plate surface thereof abuts against the projection 34b of the fitting member 34.

The operating portion 53 is formed to extend the arc portion 52 so as to have an angle relative to the proximal portion 51. Accordingly, resilient deformation of the operating portion 53 in a parallel to the proximal portion 51 generates the resilient force. A guiding groove 52a is formed from the arc portion 52 to the operating portion 53 for fitting the shoe web 11a therein. A guiding opening 53a is formed in the operating portion 53 at an intermediate portion of the guiding groove 52a for fitting the flat end of the fitting member 34 and the shoe web 11a therein.

The operating portion 53 is a portion resiliently abutting against the shoe web 11a. A protrusion 53c is formed at an end thereof, and the protrusion 53c directly abuts against an inner circumferential end surface of the shoe web 11a.

The arm 54 extending from one side surface of the operating portion 53 is bent at an appropriate portion thereof in an almost right angle relative to the operating portion 53. The pawl 54a at an end thereof runs over the proximal portion 51 and reaches the adjustment teeth 33a of the strut 30, and the arm 54 should have a resilient property so that the pawl 54a presses against the adjustment teeth 33a. Also, in this embodiment, the proximal portion 51 and a side end portion of the operating portion 53 may be optionally formed reinforcement ribs 51b, 53d respectively by bending. The above-described driving member 50, for example, can easily be manufactured by bending a spring steel plate after die cutting in an expansion form.

<5> Process of Assembling the Driving Member

A process of assembling the driving member 50 on the strut 30 and between the strut 30 and the first brake shoe 11 will be explained next. The insertion hole 51a of the proximal portion 51 fits on the flat end of the fitting member 34 of the strut 30. When the strut 30 is pressed so that the guiding groove 52a and the guiding opening 53a receive the shoe web 11a, the proximal portion 51 abuts against the projection 34b to position thereof and the protrusion 53c abuts against the inner circumferential end surface of the shoe web 11a to position thereof.

As pressing the strut 30 until a bottom of the notched groove 34a of the fitting member 34 abuts against the shoe web 11a, the driving member 50 is resiliently deformed in a U-shape as shown in FIG. 4, thereby storing a resilient force in the driving member 50.

The pawl 54a resiliently engages with the adjustment teeth 33a of the strut 30 by the resilient force of the arm 54.

<6> Automatic Shoe Clearance Adjustment Operation

An automatic shoe clearance adjustment operation will be explained next. In the drum brake device as shown in FIG. 1, when the wheel cylinder 20 is pressurized as applying the service brake, the pair of brake shoes 11 and 12 spreads apart about a point of abutment against the anchor 14 with a fulcrum, thereby making a frictional engagement with a brake drum so as to generate a braking force.

At this time, the driving member 50 follows an outward movement of the first brake shoe 11 while the operating portion 53 facing the proximal portion 51 moves apart from the proximal portion 51. When the operating portion 53 moves apart relative to the proximal portion 51, the arm 54, that is integral with the operating portion 53, moves (rotates) clockwise, and the pawl 54a at the end thereof drives the adjustment teeth 33a in one direction.

In the above-described service brake operation, as the linings 11c, 12c wear out, shoe-to-drum clearances (the gap between the linings 11c, 12c and the brake drum which is not shown in the figures) increase to also increase the amount of movement of both brake shoes 11 and 12, the amount of movement of the arm 54 exceeds a tooth pitch of the adjustment teeth 33a, and the pawl 54a drives the adjustment teeth 33a to screw the bolt 33 out from the nut 32. As a result, the entire length of the strut 30 is extended to the amount equivalent to one tooth pitch, and the returning (initial) positions of the brake shoes 11, 12 are changed so as to maintain the shoe-to-drum clearance automatically.

On the other hand, when in the parking brake operation, the strut 30 is pressed to move to the left of FIG. 1 together with the first brake shoe 11, and the driving member 50 also moves together, thereby not operating the automatic shoe clearance adjustment.

Another embodiment will be explained next. Here, the same components as described in the first embodiment have identical reference numbers and explanation of which will be omitted. Also, the automatic shoe clearance adjustment apparatus according to the following embodiment is assembled in the LT type drum brake device appeared in FIG. 1 but corresponding figures show only principal portions for the sake of easy understanding of the structure of the automatic shoe clearance adjustment apparatus.

### Second Embodiment

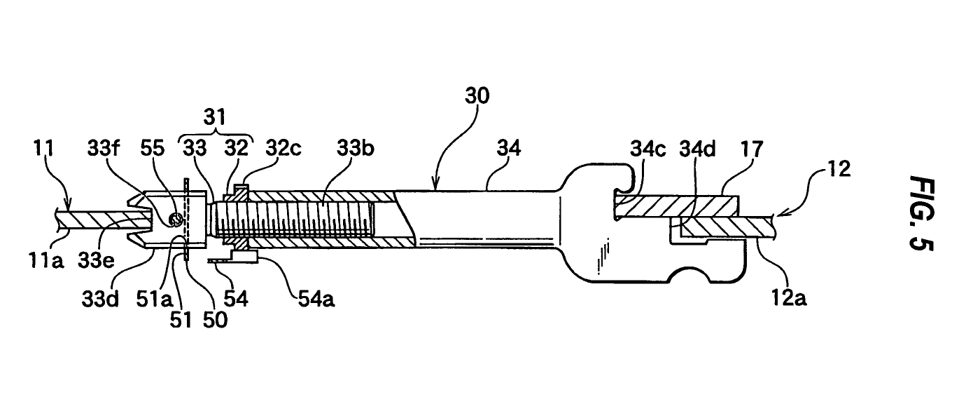

The automatic shoe clearance adjustment apparatus according to a second embodiment as shown in FIGS. 5-7 is comprised of a strut 30 having a nut 32 with adjustment teeth 32c on the peripheral surface thereof as a component, and a driving member 50 fixed on a screw-engaging unit 31 of the strut 30 by a rivet 55. The detailed structure thereof will be explained next.

<1> Strut

The strut 30 as shown in FIG. 5 is comprised of the screw-engaging unit 31 having a nut 32 and a bolt 33 screwed therebetween and a fitting member 34 rotatably fitting to the screw-engaging unit 31. In this embodiment, the bolt 33 engages with the shoe web 11a of the first brake shoe 11, and the fitting member 34 engages with the brake lever 17 and the shoe web 12a of the second brake shoe 12.

The screw-stem 33b of a right side of the bolt 33 rotatably and slidably fits in a bore of the fitting member 34, and the end surface of the fitting member 34 abuts against the nut 32, thereby positioning thereof. A notched groove 33e is formed at a head 33d with a rectangular shape in a cross section at the left side of the bolt 33 and the shoe web 11a fits in the notched groove 33e, thereby disabling the rotation of the bolt 33. Furthermore, a through hole 33f is formed in the head 33d so as to fix a proximal portion 51 of the driving member 50 to the strut 30 by a rivet 55.

A notched groove 34c and a stepped portion 34d continuing from the notched groove 34c are formed at the right end of a flat end of the fitting member 34, and the brake lever 17 fits in the notched groove 34c while the shoe web 12a of the second brake shoe 12 fits in a space formed between the stepped portion 34d and the brake lever 17, thereby disabling the rotation of the fitting member 34. Accordingly, the nut 32 is rotated via the adjustment teeth 32c, which enables the bolt 33 to screw in and out from the nut 32.

<2> Driving Member

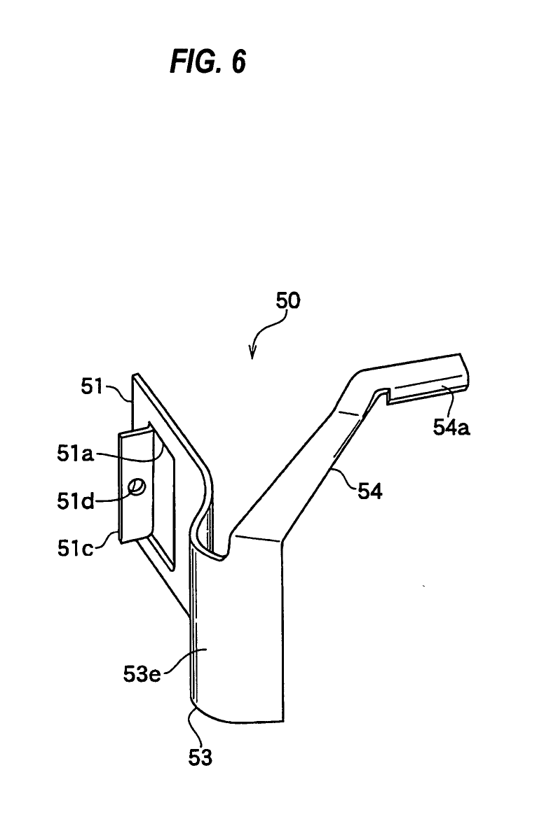

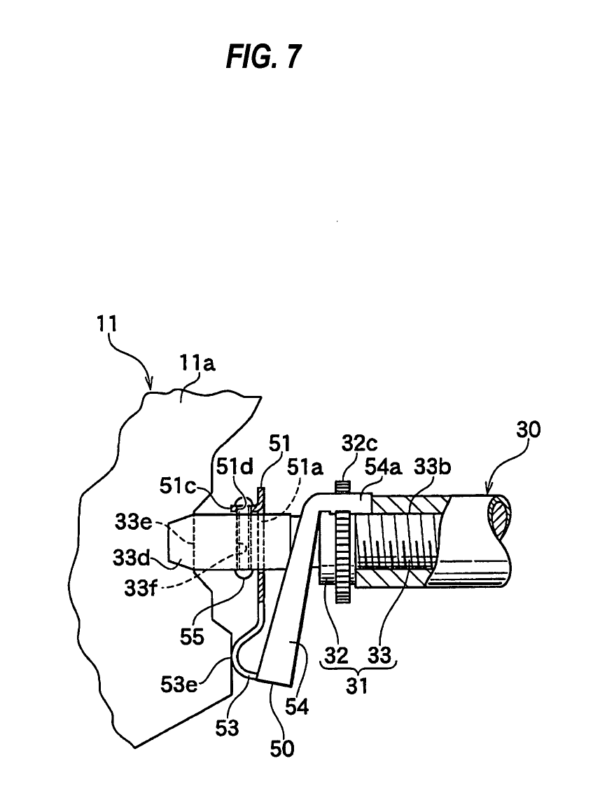

FIG. 6 shows an overall perspective view of the driving member 50 and FIGS. 5 and 7 show the driving member 50 being assembled between the strut 30 and the first brake shoe 11. The driving member 50 is comprised of a proximal portion 51 fixed to the screw-engaging unit 31 of the strut 30 at a side being near the first brake shoe 11; an operating portion 53, which is formed by extending the proximal portion 51 to resiliently abut against the brake shoe 11 between the brake shoe 11 and the strut 30 at a longitudinal direction of the strut 30; and an arm 54, which is formed by extending from the operating portion 53 toward adjustment teeth 32c of the strut 30 and is formed with a pawl 54a to make a ratchet engagement with the adjustment teeth 32c so as to drive the adjustment teeth 32c in one direction at an end thereof.

The driving member 50 will be explained in detail with reference to FIGS. 6 and 7. The proximal portion 51 is in a plate shape and has a rectangular insertion hole 51a to fit the head 33d of the bolt 33 therein and a fixing strip 51c formed by partial-shearing and bending almost to a right angle at one side of the rectangular insertion hole 51a. An installation hole 51d is formed at an intermediate portion of the fixing strip 51c to fix the driving member 50 to the bolt 33 in cooperation with the rivet 55 and the through hole 33f.

The operating portion 53 has an almost S-shape protrusion 53e.

The arm 54 is formed so as to resiliently abut the pawl 54a against the adjustment teeth 32c.

<3> Process of Assembling the Driving Member

A process of assembling the driving member 50 on the strut 30 and between the strut 30 and the first brake shoe 11 will be explained with reference to FIG. 7. The proximal portion 51 fits to the head 33d of the bolt 33 and caulked by the rivet 55 penetrated through the installation hole 51d and the through hole 33f, thereby fixing the driving member 50 to the bolt 33. Then, the bolt 33 and the nut 32 are screwed to each other to assemble the screw-engaging unit 31, and the fitting member 34 fits to the screw-stem 33b of the bolt 33 to assemble the strut 30.

Thereafter, a simple step of fitting the notched groove 33e of the head 33d to the shoe web 11a is sufficient for assembling the driving member 50 between the first brake shoe 11 and the strut 30.

As the strut 30 is pressed until the bottom of the notched groove 33e abuts against the shoe web 11a of the first brake shoe 11, the protrusion 53e of the operating portion 53 abutting against the inner circumferential end surface of the shoe web 11a is thrust, and the driving member 50 is resiliently deformed to store the resilient force in the driving member 50.

In addition, the pawl 54a of the arm 54 resiliently engages with the adjustment teeth 32c of the nut 32

<4> Automatic Shoe Clearance Adjustment Operation

An automatic shoe clearance adjustment operation in this second embodiment is identical to the above-described first embodiment and therefore the explanation of which is omitted here.

### Third Embodiment

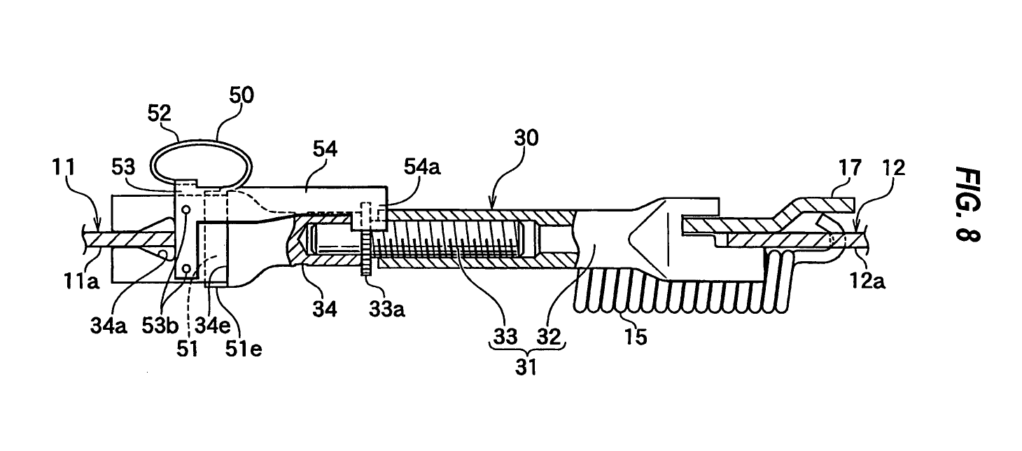

The automatic shoe clearance adjustment apparatus according to a third embodiment as shown in FIGS. 8-11 is based on the strut 30 identical to the above-described first embodiment and has a driving member 50 with different layout and operation from the first embodiment. The structure and the functions of the strut 30 in this third embodiment are identical to that of the first embodiment and therefore the explanation thereof is omitted here.

<1> Driving Member

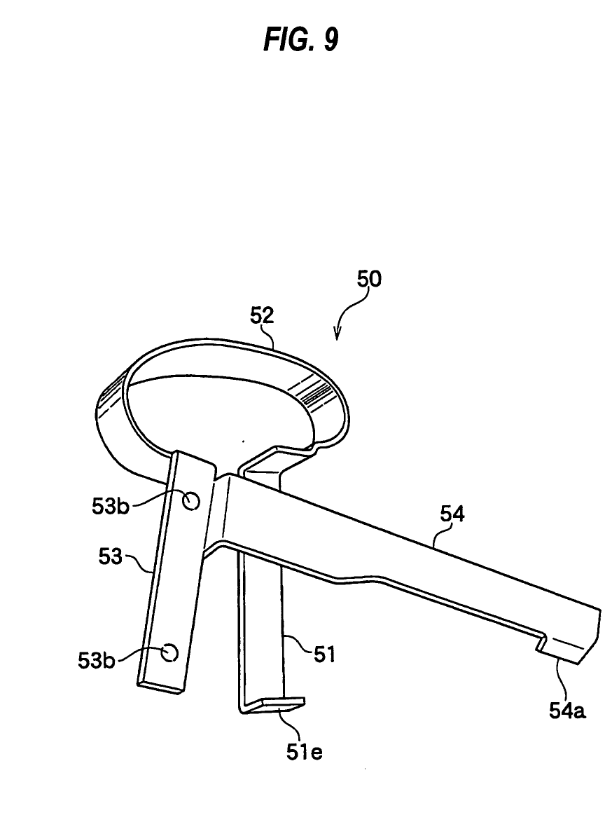

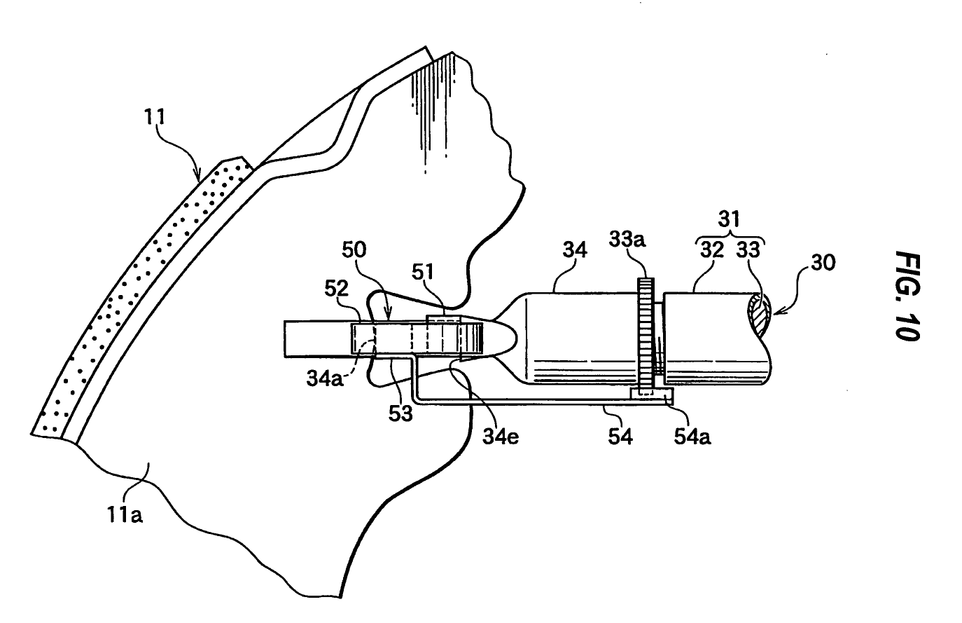

FIG. 9 shows an overall perspective view of the driving member 50 and FIGS. 8 and 10 show the driving member 50 being assembled between the strut 30 and the first brake shoe 11.

The driving member 50 is comprised of an arc portion 52, a proximal portion 51 lineally extending from one side surface at one end side of the arc portion 52 and being fixed to the fitting member 34 of the strut 30, an operating portion 53 lineally extending from the other side surface at the other end side of the arc portion 52 so as to resiliently abut against the first brake shoe 11 between the first brake shoe 11 and the strut 30 in a longitudinal direction of the strut 30, and an arm 54 which is formed by lineally extending from one portion of the operating portion 53 toward the adjustment teeth 33a of the strut 30 and formed with a pawl 54a at the end to make a ratchet engagement with the adjustment teeth 33a so as to drive the adjustment teeth 33a in one direction at an end thereof.

The driving member 50 will be explained in detail with reference to FIGS. 8-10. The proximal portion 51 is formed in an almost right angle relative to the plate surface of the arc portion 52, and the operating portion 53 is formed in an almost right angle relative to the plate surface of the arc portion 52. The proximal portion 51 and the operating portion 53 are shaped so as to resiliently catch, by the resilient force, both planes of the flat end of the fitting member 34 constituting the strut 30 at a side being near to the first brake shoe.

The end of the proximal portion 51 is bent toward the arm 54 to form a holding piece 51e so as to hold the flat end in the rectangular shape in the cross section, and a square-built C-shaped portion is formed in cooperation with the holding piece 51e, the proximal portion 51, and an end part of the arc portion 52 adjacent to the proximal portion 51, which fit to the flat end with the rectangular shape in cross section of the fitting member 34 so as to catch and hold both side surfaces of the flat end. Also, a side surface of the C-shaped portion abuts against a wall 34e formed around a border of the flat end and a cylindrical portion of the fitting member 34 for positioning thereof.

In order to accomplish the smooth movement (rotation) of the operating portion 53 integrated with the arm 54, single or plural projections 53b are optionally raised toward the plate surface of the flat end of the fitting member 34 on the plate surface of the operating portion 53 abutting against one side surface of the flat end of the fitting member 34. The projection 53b is a means to reduce the frictional resistance on a contacting surface between the flat end and the operation portion.

The arm 54 is formed by first extending one portion of the operating portion 53 in a right angle relative to the operating portion 53 and secondly bending so that the pawl 54a at the end exceeds the proximal portion 51 to reach the adjustment teeth 33a of the strut 30 and also so that the pawl 54a is resiliently abutted against the adjustment teeth 33a.

<2> Process of Assembling the Driving Member

A process of assembling the driving member 50 on the strut 30 and between the strut 30 and the first brake shoe 11 will be explained next. The proximal portion 51 and the operating portion 53 move apart from each other, and upon placing the fitting member 34 therein, the fitting member 34 is placed between the holding piece 51e formed on the proximal portion 51 and the arc portion 52, thereby fixing the driving member 50 to the strut 30.

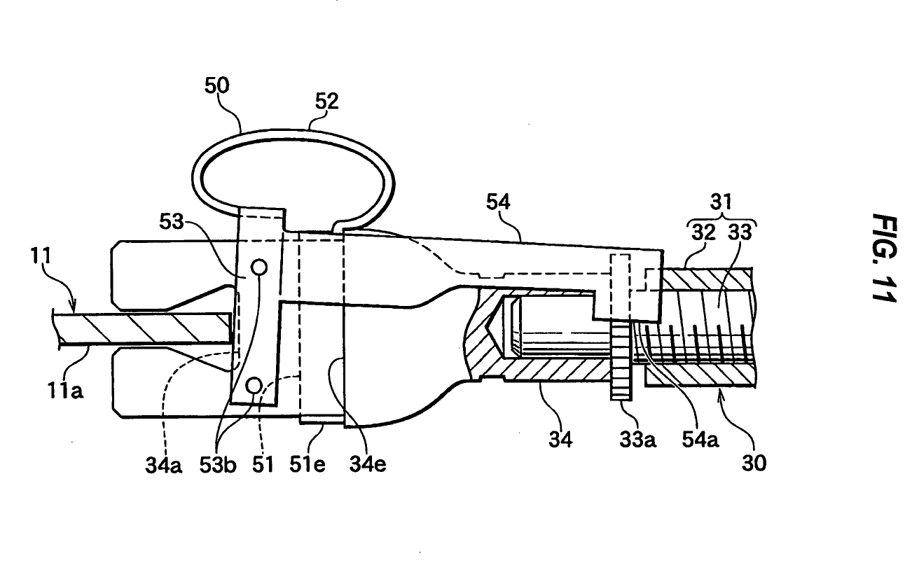

The driving member 50 is installed on the fitting member 34 of the strut 30 by a holding force of the holding piece 51e and the arc portion 52. However, the resilient force attempting to press the operating portion 53 to the fitting member 34 devotes to the stable fixing of the proximal portion 51. Furthermore, while the driving member 50 is positioned by fixing to the strut 30, as show in FIG. 11, a left end surface of the operating portion 53 is positioned further outside than a bottom of the notched groove 34a of the fitting member 34.

Then, simply by fitting the notched groove 34a of the fitting member 34 to the shoe web 11a, the driving member 50 can be assembled and properly positioned between the brake shoe 11 and the strut 30. While the strut 30 is being pressed until the bottom surface of the notched groove 34a abuts against the shoe web 11a, the left end surface of the operating portion 53 firstly abuts against the shoe web 11a and is thrust, and the operating portion 53 with the arm 54 moves (rotates) counterclockwise to move the condition from FIG. 11 to FIG. 8. At that time, the resilient force is stored in the driving member 50.

The pawl 54a resiliently engages with the adjustment teeth 33a of the strut 30 by a resilient force of the arm 54.

<3> Automatic Shoe Clearance Adjustment Operation

An automatic shoe clearance adjustment operation of this third embodiment is basically identical to the above-described first embodiment and therefore the explanation thereof will be omitted.

In the third embodiment, the arm 54 of the driving member 50 can be positioned close to the strut 30, and at the same time the proximal portion 51 and the operating portion 53 do not exceed out from the strut 30, and therefore a circumferential space around the strut 30 becomes large which gives an advantage of facilitating the assembly of the shoe return spring 15. Furthermore, the driving member 50 can be a small and simple shape, which facilitates the manufacturing process and therefore the cost for the same is decreased as well as the ease of assembly of the same to the strut 30.

### Fourth Embodiment

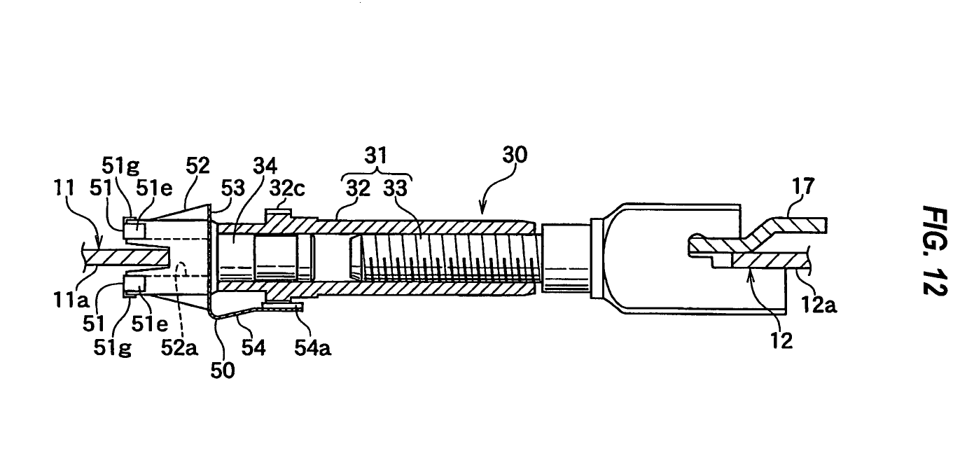

The automatic shoe clearance adjustment apparatus according to a fourth embodiment as shown in FIGS. 12-14 is comprised of a strut 30 having a cylindrical nut 32 with adjustment teeth 32c on the peripheral surface thereof as a component and a driving member 50 attached to a fitting member 34 of the strut 30 and automatically extends the entire length of the strut 30 by the resilient force for pressing an arc portion 52. The detailed structure thereof will be explained below.

<1> Strut

The strut 30 as shown in FIG. 12 is comprised of the screw-engaging unit 31 having the bolt 33 and the nut 32 screwed therebetween and the fitting member 34 rotatably fitting to the screw-engaging unit 31. In this embodiment, the fitting member 34 engages with the shoe web 11a of the first brake shoe 11 and the bolt 33 of the screw-engaging unit 31 engages with the shoe web 12a of the second brake shoe 12.

<2> Driving Member

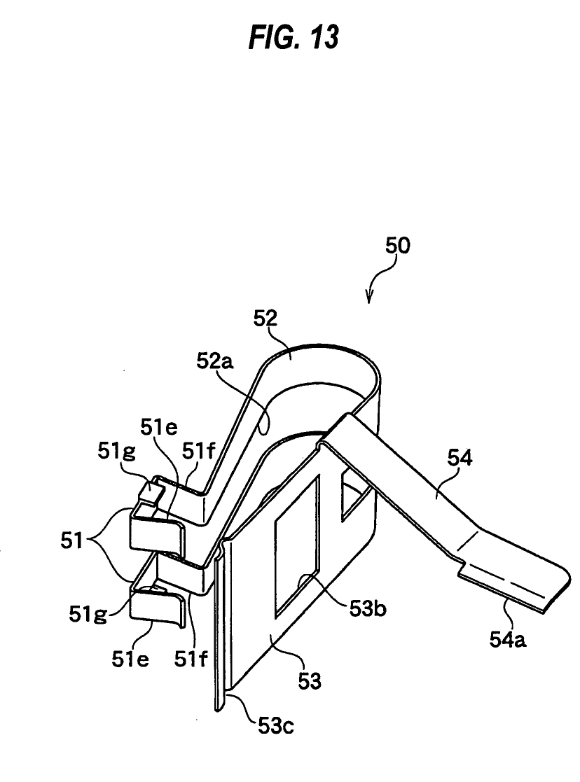

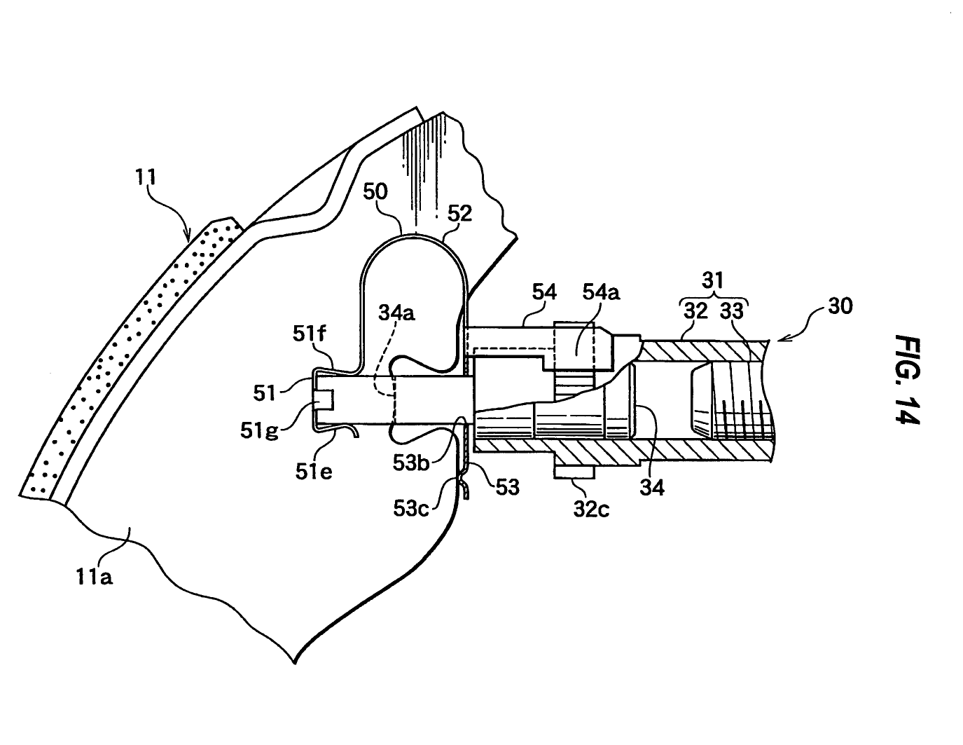

FIG. 13 shows an overall perspective view of the driving member 50 and FIGS. 12 and 14 show the driving member 50 being assembled between the strut 30 and the first brake shoe 11.

The driving member 50 is comprised of a proximal portion 51 which is fixed to the fitting member 34 of the strut 30 at the first brake shoe 11 side, an arc portion 52 which is formed by extending the proximal portion 51 to be curved at a position as proceeding apart from the proximal portion 51, an operating portion 53 which is formed by extending the arc portion 52 so as to resiliently abut against the brake shoe 11 between the brake shoe 11 and the strut 30 in a longitudinal direction of the strut 30, and an arm 54 which is formed by extending from the operating portion 53 toward the adjustment teeth 32c and formed with the pawl 54a making a ratchet engagement with the adjustment teeth 32c so as to drive the adjustment teeth 32c in one direction at an end thereof.

The driving member 50 will be explained in detail with reference to FIGS. 13 and 14. A band shaped section, composed of the proximal portion 51, the arc portion 52, and the operating portion 53, is designed to fit to the shoe web 11a of the first brake shoe 11. The guiding groove 52a is formed from an end of the proximal portion 51 to the operating portion 53 and the insertion opening 53f is formed in the operating portion 53 so as to fit the flat end of the fitting member 34 therein.

A pair of the proximal portions 51 and 51 has square-built almost C-shaped holding pieces 51e and 51f and a hooking piece 5g formed by bending the outer side end of the proximal portion 51, which is able to fit to the flat end of that fitting member 34 at an end side thereof.

Similar to the first embodiment, the operating portion 53 has the protrusion 53c abuttable against the internal circumferential end surface of the shoe web 11a.

The driving member 50 is designed such that the curving of the arc portion 52 is bent so that the operating portion 53 is positioned closer to the proximal portion 51 facing the operating portion 53 while the proximal portion 51 is fixed to the fitting member 34.

<3> Process of Assembling the Driving Member

A process of assembling the driving member 50 on the strut 30 and between the strut 30 and the first brake shoe 11 will be explained next. The flat end of the fitting member 34 fits in the insertion opening 53f, and at the same time the end thereof is held by the holding pieces 51e, 51f and the hooking pieces 51g, 51g, thereby fixing the proximal portion 51 of the driving member 50 to the strut 30.

Then, simply by pressing the fitting member 34 in the shoe web 11a, the driving member 50 can be assembled between the first brake shoe 11 and the strut 30. During this operation, the protrusion 53c of the operating portion 53 abuts against the shoe web 11a. Furthermore, by pressing the strut 30 until the bottom of the notched groove 34a abuts against the shoe web 11a, the operating portion 53 abutting against the inner circumferential surface of the shoe web 11a is pressed, and the operating portion 53 with the arm 54 moves (rotates) counterclockwise to move to the condition as shown in FIG. 14, thereby storing the resilient force in the driving member 50.

The pawl 54a of the arm 54 resiliently engages with the adjustment teeth 32c of the strut 30 by a resilient force of the arm 54.

<4> Automatic Shoe Clearance Adjustment Operation

An automatic shoe clearance adjustment operation will be explained next. When the service brake is in operation, as an axial force operating on the strut 30 is being released if the brake shoes 11, 12 move to spread apart, the operating portion 53 and the arm 54 moves (rotates) with the middle portion of the arc portion 52 as the center. When the amount of movement of the brake shoes 11, 12 increases and the amount of movement (rotation) of the arm 54 of the driving member 50 exceeds the tooth pitch of the adjustment teeth 32c, the pawl 54a at the end thereof drives the adjustment teeth 32c in a saw tooth shape to screw the nut 32 out from the bolt 33. As a result, the entire length of the strut 30 is extended to automatically adjust the shoe-to-drum clearance.

In the fourth embodiment, the proximal portion 51 needs to be abuttable against the end of the flat end of the fitting member 34, and therefore the holding pieces 51e, 51f and the hooking pieces 51g, 51g are not necessary features and can be optionally omitted. A hooking position of the proximal portion 51 may be formed around the bottom of the notched groove 34a.

In the fourth embodiment, because the proximal portion 51 positioned in one side of the driving member 50 is held on the end of the fitting member 34 of the strut 30 and the operating portion 53 positioned in the other side of the driving member 50 abuts against the inner circumferential end surface of the shoe web 11a for positioning thereof, this embodiment has an advantage in that processing the step (e.g., a projection and a wall surface formed on the strut 30) required in the above-described embodiments 1 and 3 for positioning the driving member 50 can be omitted.

### Fifth Embodiment

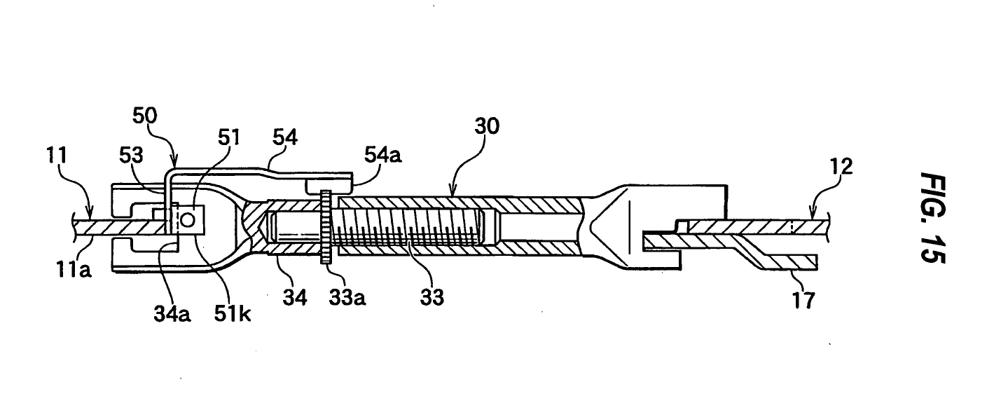

The automatic shoe clearance adjustment apparatus according to the fifth embodiment as shown in FIGS. 15-17 is comprised of a strut 30 similar to the above-described first embodiment and a driving member 50 fixed to the fitting member 34 by welding. The structure and functions of the strut 30 in the fifth embodiment are similar to that of the first embodiment, and therefore the explanation thereof is omitted here.

<1> Driving Member

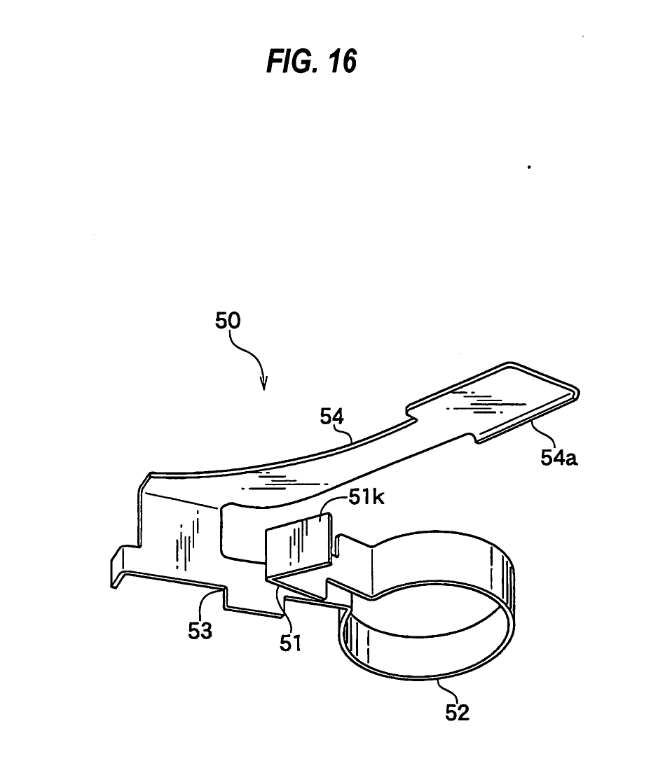

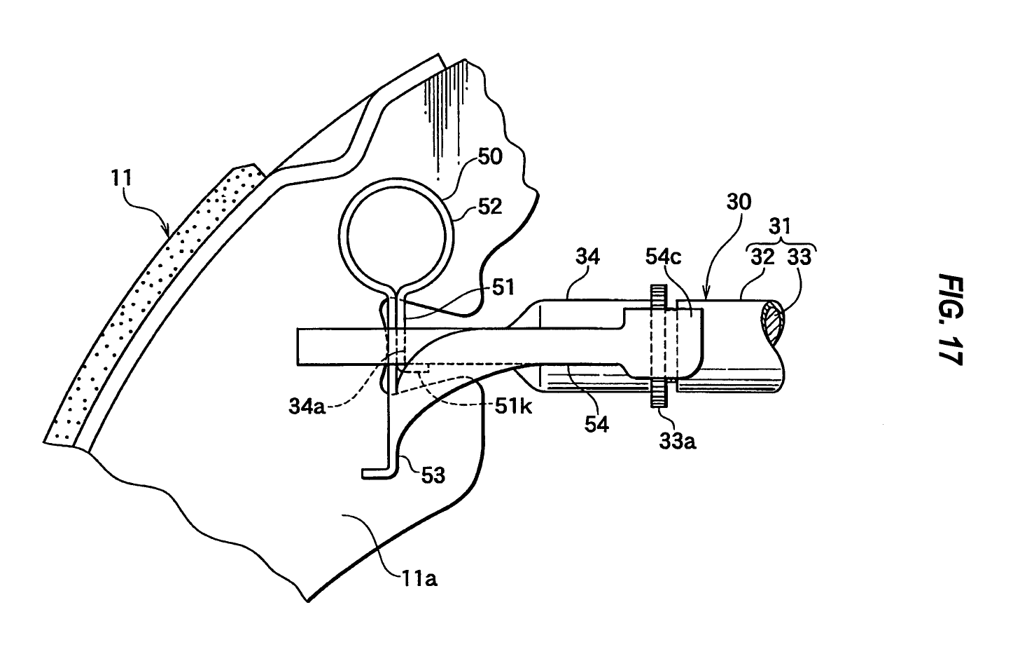

FIG. 16 shows an overall perspective view of the driving member 50, and FIGS. 15 and 17 show a driving member 50 being assembled between the strut 30 and the first brake shoe 11.

The driving member 50 is comprised of a proximal portion 51 fixed to the fitting member 34 by welding, an arc portion 52 formed in an almost ring shape by extending the proximal portion 51 to be curved at a position as proceeding apart from the proximal portion 51, an operating portion 53 formed by extending the arc portion 52 so as to face to the proximal portion 51 and placed between the brake shoe 11 and the strut 30 in a longitudinal direction of the strut 30 with resiliently deforming, and an arm 54 formed by extending from the operating portion 53 toward the adjustment teeth 33a and formed with a pawl 54a to make the ratchet engagement with the adjustment teeth 33a so as to drive in one direction at an end thereof.

The driving member 50 will be explained in detail with reference to FIGS. 15-17. The proximal portion 51 and the operating portion 53 are sized to be able to fit in the groove of the notched groove 34a of the fitting member 34. A portion around the end of the proximal portion 51 is bent in an L-shape to form a fixing piece 51k so as to fix to the flat end of the fitting member 34 by such as welding. The arm 54 extending from the side surface of the operating portion 53 is bent in an almost right angle relative to the operating portion 53, the pawl 54a at the end thereof extends to reach the adjustment teeth 33a and at the same time, the pawl 54a of the arm 54 resiliently abuts against the adjustment teeth 33a.

The driving member 50, while the proximal portion 51 thereof being fixed on the fitting member 34, is shaped to open both ends, i.e., the end of the operating portion 53 positioned apart from the proximal portion 51.

<2> Process of Assembling the Driving Member

A process of assembling the driving member 50 on the strut 30 and between the strut 30 and the first brake shoe 11 will be explained next. The proximal portion 51 and the operating portion 53 are fit in the groove of the notched groove 34a of the fitting member 34, and the fixing piece 51k extending from the proximal portion 51 abutting against the bottom of the notched groove 34a, is fixed to the side surface of the fitting member 34 by welding.

Then, simply by pressing the fitting member 34 to fit to the shoe web 11a, the driving member 50 can be assembled between the brake shoe 11 and the strut 30. During this operation, the operating portion 53 abuts against the shoe web 11a. Furthermore, the strut is pressed until the operating portion 53 is superposed on the proximal portion 51, and therefore the driving member 50 stores the resilient force.

<3> Automatic Shoe Clearance Adjustment Operation

An automatic shoe clearance adjustment operation will be explained next. The operating portion 53 of the driving member 50 displaces following the movement of both brake shoes 11 and 12. The amount of movement of both brake shoes 11 and 12 increases, then the amount of movement (rotation) of the arm 54 exceeds the tooth pitch of the adjustment teeth 33a, and the pawl 54a at the end thereof drives the adjustment teeth 33a to screw the bolt 33 out from the nut 32. As a result, the entire length of the strut 30 is extended to the amount equivalent to one tooth pitch, thereby automatically adjusting the shoe-to-drum clearance.

In the fifth embodiment, the holding piece for fixing the driving member 50 is not required, thereby simplifying the manufacturing process, and the proximal portion 51 of the driving member 50 is firmly fixed on the strut 30 by welding, thereby providing more secure fixing and eliminating a case of disengagement of the driving member 50 during transportation or handling.

### Sixth Embodiment

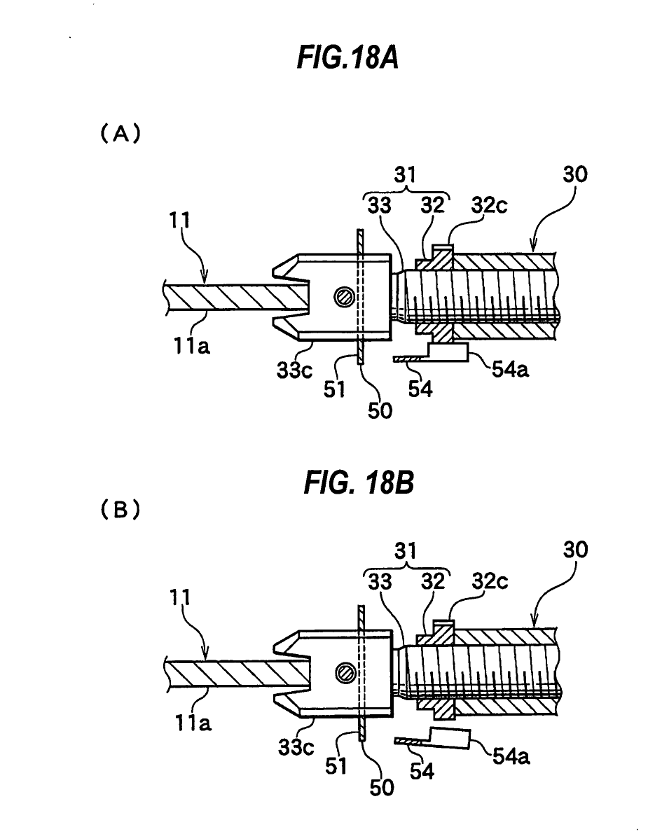

FIG. 18 illustrates a sixth embodiment where the driving member 50 has a shoe clearance over-adjustment prevention means for suspending the automatic shoe clearance adjustment when the temperature in the brake reaches a predetermined value or range. This shoe clearance over-adjustment prevention means is comprised of a publicly known thermo-sensitive member. The pawl 54a of the arm 54 is engaged with the adjustment teeth 32c until the atmospheric temperature around the driving member 50 reaches a predetermined value or range as shown in FIG. 18A. The pawl will become disengaged with the adjustment teeth 32c by outwardly deforming the pawl 54a so that the pawl 54a departs from the adjustment teeth 32c when the temperature in the brake reaches a predetermined value or range.

As described above, in order to deform the pawl 54a to depart from the adjustment teeth 32c, the arm 54 may be made of bimetal or shape memory alloy. Alternatively, at least the arm 54 to some length may be made of bimetal or shape memory alloy and the rest may be made of non-thermo-sensitive material, both of which can be jointed, such as by a rivet. FIG. 18 shows an embodiment employing the shoe clearance over-adjustment prevention means in the driving member 50 described in the second embodiment, but the shoe clearance over-adjustment prevention means can be employed in the driving member 50 of any one of the first, third, fourth, and fifth embodiments.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What we claim is:

1. An automatic shoe clearance adjustment apparatus having:
a strut and a driving member,
said strut is comprised of a screw-engaging unit having a nut and a bolt screwed therebetween and a fitting member rotatably fitting with said screw-engaging unit, and extended between one brake shoe and the other brake shoe, and
said driving member engages with adjustment teeth integrated with said screw-engaging unit of the strut,
in which said automatic shoe clearance adjustment apparatus has an automatic shoe clearance adjustment mechanism, automatically extending an entire length of said strut to adjust a shoe-to-drum clearance by driving the adjustment teeth in one direction when strokes of the brake shoes exceed a predetermined value or range, wherein
said driving member is comprised of a proximal portion fixed on said strut at a side being near to said one brake shoe,
an operating portion extending from said proximal portion and resiliently abutting against said one brake shoe between said one brake shoe and said strut in a longitudinal direction of said strut, and
an arm having a pawl extending from said operating portion toward said adjustment teeth to make an engagement therebetween.

2. The automatic shoe clearance adjustment apparatus according to claim 1, wherein
said proximal portion of the driving member is fixed to an axial line of said strut, and
said operating portion of the driving member abuts against said one brake shoe on the axial line of said strut between said one brake shoe and said proximal portion.

3. The automatic shoe clearance adjustment apparatus according to claim 1, wherein
said proximal portion of the driving member is fixed to said strut by fitting.

4. The automatic shoe clearance adjustment apparatus according to claim 2, wherein
said proximal portion of the driving member is fixed to said strut by fitting.

5. The automatic shoe clearance adjustment apparatus according to claim 1, wherein
said adjustment teeth is integrally formed with said bolt of the screw-engaging unit, and
said fitting member engages with one of said pair of brake shoes and said nut engages with the other of said pair of brake shoes.

6. The automatic shoe clearance adjustment apparatus according to claim 2, wherein
said adjustment teeth is integrally formed with said bolt of the screw-engaging unit, and
said fitting member engages with one of said pair of brake shoes and said nut engages with the other of said pair of brake shoes.

7. The automatic shoe clearance adjustment apparatus according to claim 3, wherein
said adjustment teeth is integrally formed with said bolt of the screw-engaging unit, and
said fitting member engages with one of said pair of brake shoes and said nut engages with the other of said pair of brake shoes.

8. The automatic shoe clearance adjustment apparatus according to claim 4, wherein
said adjustment teeth is integrally formed with said bolt of the screw-engaging unit, and
said fitting member engages with one of said pair of brake shoes and said nut engages with the other of said pair of brake shoes.

9. The automatic shoe clearance adjustment apparatus according to claim 1, wherein
said adjustment teeth is integrally formed with said nut of the screw-engaging unit, and
said fitting member engages with one of said pair of brake shoes and said bolt engages with the other of said pair of brake shoes.

10. The automatic shoe clearance adjustment apparatus according to claim 2, wherein
said adjustment teeth is integrally formed with said nut of the screw-engaging unit, and
said fitting member engages with one of said pair of brake shoes and said bolt engages with the other of said pair of brake shoes.

11. The automatic shoe clearance adjustment apparatus according to claim 3, wherein
said adjustment teeth is integrally formed with said nut of the screw-engaging unit, and
said fitting member engages with one of said pair of brake shoes and said bolt engages with the other of said pair of brake shoes.

12. The automatic shoe clearance adjustment apparatus according to claim 4, wherein
said adjustment teeth is integrally formed with said nut of the screw-engaging unit, and
said fitting member engages with one of said pair of brake shoes and said bolt engages with the other of said pair of brake shoes.

13. The automatic shoe clearance adjustment apparatus according to claim 1, wherein
an over adjustment prevention means is provided on said arm of the driving member, said over adjustment prevention means suspends an automatic shoe clearance adjustment operation by disengaging said arm from said adjustment teeth by thermo-deflecting of the arm when a temperature within the brake exceeds a predetermined value or range.

14. The automatic shoe clearance adjustment apparatus according to claim 2, wherein
an over adjustment prevention means is provided on said arm of the driving member, said over adjustment prevention means suspends an automatic shoe clearance adjustment operation by disengaging said arm from said adjustment teeth by thermo-deflecting of the arm when a temperature within the brake exceeds a predetermined value or range.

15. The automatic shoe clearance adjustment apparatus according to claim 3, wherein
an over adjustment prevention means is provided on said arm of the driving member, said over adjustment prevention means suspends an automatic shoe clearance adjustment operation by disengaging said arm from said adjustment teeth by thermo-deflecting of the arm when a temperature within the brake exceeds a predetermined value or range.

16. The automatic shoe clearance adjustment apparatus according to claim 4, wherein
an over adjustment prevention means is provided on said arm of the driving member, said over adjustment prevention means suspends an automatic shoe clearance adjustment operation by disengaging said arm from said adjustment teeth by thermo-deflecting of the arm when a temperature within the brake exceeds a predetermined value or range.

17. The automatic shoe clearance adjustment apparatus according to claim 5, wherein
an over adjustment prevention means is provided on said arm of the driving member, said over adjustment prevention means suspends an automatic shoe clearance adjustment operation by disengaging said arm from said adjustment teeth by thermo-deflecting of the arm when a temperature within the brake exceeds a predetermined value or range.
